(19) United States
(12) Patent Application Publication
(10) Pub. No.: US 2015/0035287 A1
(43) Pub. Date: Feb. 5, 2015

(54) BLOCK LOADING OF GENERATOR SET

(71) Applicant: GE Jenbacher GmbH & Co OG, Jenbach (AT)

(72) Inventors: Erich KRUCKENHAUSER, Muenster (AT); V. SADHASIVAM, Tamilnadu (IN)

(21) Appl. No.: 14/337,570

(22) Filed: Jul. 22, 2014

(30) Foreign Application Priority Data
Aug. 5, 2013 (AT) 625/2013

(51) Int. Cl. F02D 29/06

(52) U.S. Cl. CPC F02D 29/06
USPC 290/40 A

(57) ABSTRACT

Method of operating a generator set, comprising a combustion engine with a drive shaft coupleable with a generator to supply electrical power, and at least one internal appliance coupleable to the drive shaft creating resistance to the drive shaft, particularly a fan, wherein a rotary speed of the drive shaft and/or a voltage and/or a frequency from the generator is monitored, wherein the resistance of the at least one internal appliance to the drive shaft is at least temporarily reduced when the rotation speed of the drive shaft and/or the voltage and/or the frequency from the generator drops below a predefinable threshold.

### BACKGROUND OF THE INVENTION

The present invention relates to a method of operating a generator set, comprising a combustion engine with a drive shaft coupleable with a generator to supply electrical power, and at least one internal appliance coupleable to the drive shaft creating resistance to the drive shaft, particularly a fan, wherein a rotary speed of the drive shaft and/or a voltage and/or a frequency from the generator is monitored.

A prior art of the method of operating a generator set comprising a combustion engine is known from the US patent U.S. Pat. No. 8,205,594 which describes a generator set control system and more particularly a generator set control system having predictive load management.

Suddenly increasing load to the generator set, a so called block loading, is causing sudden reduction of the combustion engine speed with resulting fluctuating power output from the generator. Block loading means, when the engine is running, the generator set experiences a sudden increase in load due to the planned requirement. Especially the event of block loading may happen, when an external electrical load is applied suddenly to the generator—the generator will attempt to provide for the increase in electrical power demand by drawing more mechanical power from the engine and converting the additional mechanical power to electrical power. As a result of the increase of mechanical load, the engine may reduce the speed on the drive shaft as the resistance on the shaft increases. Until additional fuel and air can be directed into the engine, the engine compensates with producing a higher output of mechanical power required by the generator and tries to recover. That means that block loading causes a temporary increase of fuel consumption. If block loading appears very often to a generator set, it could be that the electrical power output is not constant. But this is important for the use of the generator set, because the variation in a frequency may affect the speed of, for example, an electrical motor that is needed in a process where it is very important to have constant speed on the shaft of the electric motor.

Fluctuation in the power lines may also affect electronic equipments like computers, or also simple lighting systems that for example lights are not lighting constant. To solve this problem a bigger generator set could be used to compensate the block loading. A bigger generator set may use a stronger combustion engine, what generally has got higher fuel consumption and is not as economical like a smaller generator set that is working more efficient because of an intelligent control system.

### SUMMARY OF THE INVENTION

The object of the present invention is having a generator set that is more efficient, not oversized and able to compensate block loading without increasing fuel consumption and creating fluctuate power output.

The characteristics features of the invention are presented in detail below.

An example to prevent block load on a generator set could be, that the internal appliance, for example the radiator fan and/or the generator fan are uncoupled to the drive of the combustion engine or the drive of the generator.

Another example could be to block the cooling air flow that is passing the generator or also the combustion engine is blocked. That means, for example, that the air intake or the air exit from the generator cover could be opened or closed. Reduced airflow to the fan means minimized drag to the blades of the fan; subsequently there is less resistance to the drive shaft of the combustion engine or the generator.

If the resistance to the combustion engine has been minimized by one of the explained examples, there is temporarily less load on the engine during the recovery time from the internal appliance, what could create a so called overshoot when the event of block loading is over. That means the combustion engine is temporarily turning faster than it normally should. To prevent this overshoot in speed on the drive shaft, the load from the internal appliance, like for example the radiator fan or the generator fan, is coupled to the drive shaft again before the recovery time is over. That means that the combustion engine is set under load by the internal appliances before he is fully recovered again. Preventing overshoot is important because during the overshoot the engine consumes more fuel and creates more nitric oxide (NOₓ) during the combustion.

### BRIEF DESCRIPTION OF THE DRAWINGS

FIG. 1 is a schematically illustration of a generator set, comprising a combustion engine and a generator.

FIGS. 2A and 2B is a pictorial illustration of a fan, comprising a pulley, a clutch and a hub, connected to the drive shaft.

FIGS. 3A, 3B, 3C are schematically illustrations of a generator set with closable airflow to the radiator and the generator.

FIGS. 4A and 4B are graphs comparing speed and load of the generator set.

FIG. 5 is a schematically illustration of the radiator flaps in various locations.

FIG. 6 is a schematically illustration of a generator set, comprising safety device.

### DETAILED DESCRIPTION OF THE INVENTION

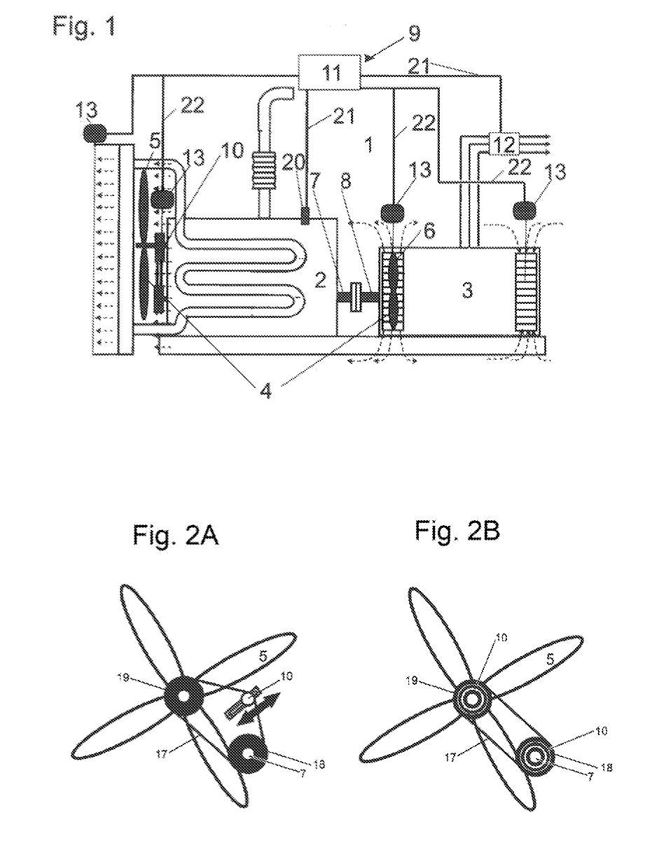

FIG. 1 illustrates an example of a generator set 1 having a combustion engine 2 and a generator 3 that provides electrical power to an external appliance over the power output lines. The combustion engine 2 comprises a radiator fan 5 for cooling; the generator 3 also comprises a generator fan 6. The radiator fan 5 and the generator fan 6 are internal appliances 4, which create resistance to the combustion engines 2 drive shaft 7 and the mechanically powered generator shaft 8 of the generator 3. When external load is suddenly increasing—the event of block loading appears, the generator 3 is temporarily forced to create more electrical power. The increase in electrical power demand subsequently means more mechanical power from the combustion engine 2. This mechanical power causes temporarily reduction of speed on the drive shaft 7. If this event appears the electrical power output is fluctuating because of a not constant running combustion engine 2 and accordingly not constant mechanically driven generator 3. These fluctuations are undesirable.

The disclosed control system, comprising a controller 11, a power output sensor 12, a speed sensor 20 and at least one actuator 13 may help minimize performance fluctuation by controlling the load from the internal appliances 4, such as a radiator fan 5 and the generator fan 6.

FIG. 2A illustrates an example for an internal appliance 4, such as radiator fan 5, that comprises a belt driven hub 19, a pulley 18 connected to the drive shaft 7 and a clutch 10. The example of a clutch 10 is actuated to an open position by an actuator 13 that is controlled by the controller 11 when block loading is monitored by the speed sensor 20, for example a crankshaft sensor or flywheel sensor, and/or the power output sensor 12. In this event, there is no more tension on the belt 17 and the mechanical connection from the fans hub 19 to the drive shaft 7 is inactive. So the load from the internal appliance 4, as example the radiator fan 5 or the generator van 6 is disconnected from the combustion engine 2 temporarily as long the block loading appears and it may take the combustion engine 2 for recovery.

To prevent overshoot, the belt 10 is tensioned by the pulley, before the recovery time has fully ended. This is managed by the controller 11 and provides temporarily overspeed on the combustion engine 2 involving fuel consumption and nitric oxide exhaust and, additionally, peaks in the electrical power supply.

FIG. 2B illustrates another example for a clutch 10 like a magnetic disc clutch at the hub 19 or also the pulley 18, which disengages the fan 5 from the combustion engine 2. This magnetic disc clutch is also actuated by the controller 11, like in the explanation of FIG. 2A.

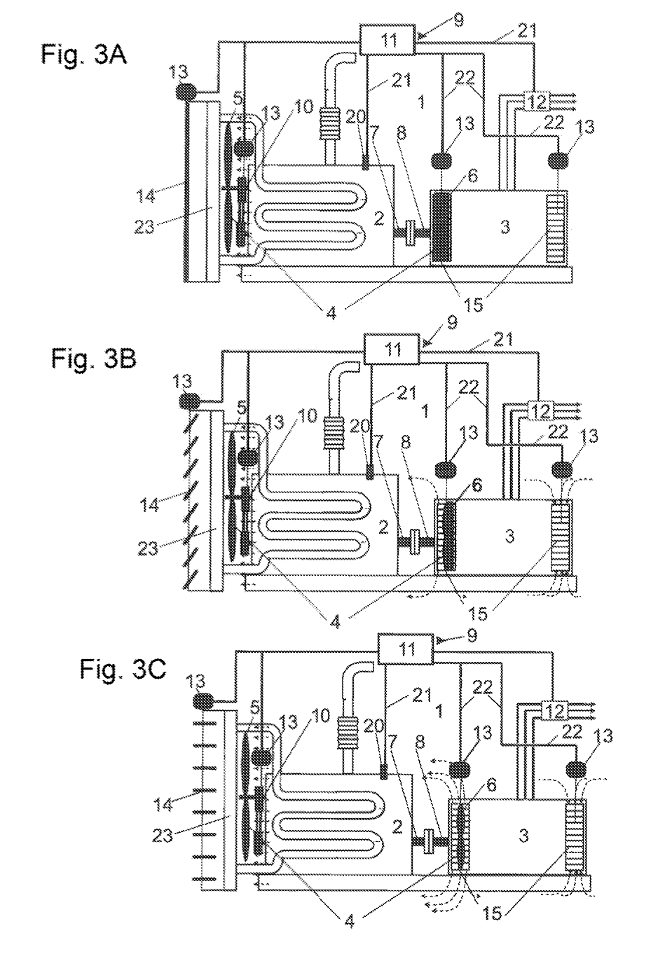

FIG. 3A illustrates an example for blocking the cooling air flow to reduce draft on the radiator fan 5 and/or the generator fan 6. The covers of the radiator fan 5 and the generator 2 have air intake and exit openings, which may be opened or closed by at least one flap. For example, like also illustrated on the FIGS. 3B and 3C, there is at least one flap on the cover of the generator 3 and the cover of the radiator fan 5 opened or closed by at least one actuator 13, for example a servo motor. In this figure the radiator flap 14 and the generator flap 15 are fully closed. There is minimized airflow, because the direction of leaving the covers is shut. Minimized airflow means minimized drag to the radiator fan 5 and/or the generator fan 6, so there is less resistance to the drive shaft of the combustion engine 2. This is comparable to a vacuum cleaner or a hair dryer, where the electrical engine is immediately increasing speed if the openings are getting closed, because the drag is missing. The actuated flaps 14, 15 are getting closed by the management of the controller 11 when block loading is monitored by the speed sensor 20 and/ or the power output sensor 12.

The flaps 14, 15 can be located at the air inlet or the air outlet of the generator 3 and the radiator 23. Or in case of the radiator 23, the flaps 14 could also be located between the radiator fan and the radiator 23.

FIG. 3B illustrates an example for providing overshoot on the generator set 1. The radiator flap 14 and the generator flap 15 are, for example, in the state between half opened and fully opened by the actuators 13. This is the state short before the overshoot, where the block load is nearly over and the recovery time also. If the radiators flap 14 and the generators flap 15 stay closed while block loading and recovery time is running out, the engine may overspeed and the generator may create a voltage peak that harms the external appliances, because of temporarily missing resistance to the drive shaft 7. So the controller 11 absorbs, by the state of the radiator flap 14 and the generator flap 15 either proportional, in predefined steps or delayed the overrun of energy and secures the system against an overshoot. Or in different words: the at least one actuator 11 couples the energy to the drive shaft 8 and/or the generators shaft 9 to the radiator fan 5 or generator fan 6 again, before the rotation speed on the drive shaft 7 and/or the generators shaft 8 equates to the predefinable second threshold y, memorized in the controller 11 to prevent an overshoot, where the rotation speed on the drive shaft 7 can be temporarily higher then requested.

In FIG. 3C the radiator flap 14 and the generator flap 15 are fully opened, providing the maximal air flow to cool the system. This is the state, where no block loading is appearing. The surrounding air is entering the cover of the generator 3 at the air intake opening, accelerated by the generator fan 6, and leaving at the air exit opening with the open generator flap 15. Also the radiator fan 5 accelerates the air to an exit opening, after the airflow was passing the combustion engine 2. The air flow is not blocked, because the at least one radiator flap 14 is fully opened.

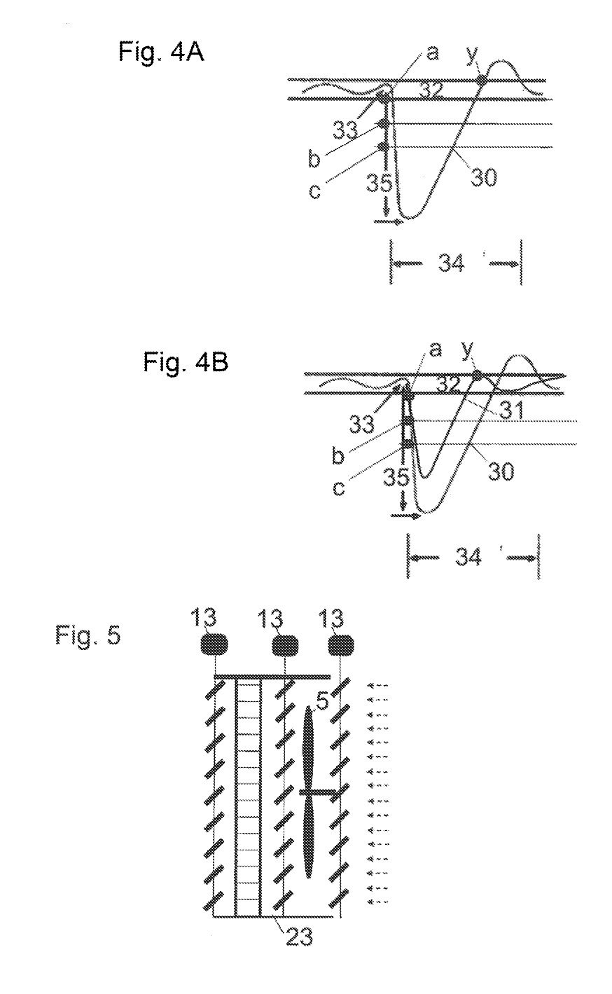

In FIG. 4A a graph is illustrated, where the speed on the drive shaft 7 is shown in a first curve 30 during the block loading on a generator set 1. The first curve 30 normally is a line with small amplitudes staying in a predefined area 32. In case of block loading, the first curve 30 is dropping below a value out of the area 32 starting at the load apply point 33. The combustion engine 2 tries to compensate the falling rotary speed on the drive shaft 7 by injecting more fuel. The first curve 30 goes up until it is in the area 32 again. The time, the combustion engine 2 needs for this event, from the load apply point 33 to the point, where the first curve 30 crosses the first threshold a, b, c of the area 32 is called recovery time 34. The kick 35 shows how deep the rotary speed is falling off during the event of block loading.

The first threshold a, b, c can be set multiple to define the area 32. Depending to the setting of the first threshold a, b, c, the flaps explained in FIG. 3A, 3B and 3C, close in different states, to block the air stream. The flaps, for example, could close from 0% to 100%, from 0% to 20%, from 0% to 40%, etc, according to the setting of the predefined level of the first threshold a, b, c and the second threshold y.

In FIG. 4B a graph illustrates, what happens when the load from the fans 5, 6 is reduced. The second curve 31 is not that long as the first curve 30, means, that the recovery time is shorter than without the invention. Also the kick 35 is not as deep as it was before in FIG. 4a.

In FIG. 5 is illustrated, that the radiator flaps 14 controlled by the actuator 13 are located in three different positions. The radiator flaps 14 can be located behind the radiator 23 and, or between the radiator 23 and the radiator fan 5 and/or before the radiator fan 5 to have influence to the air stream.

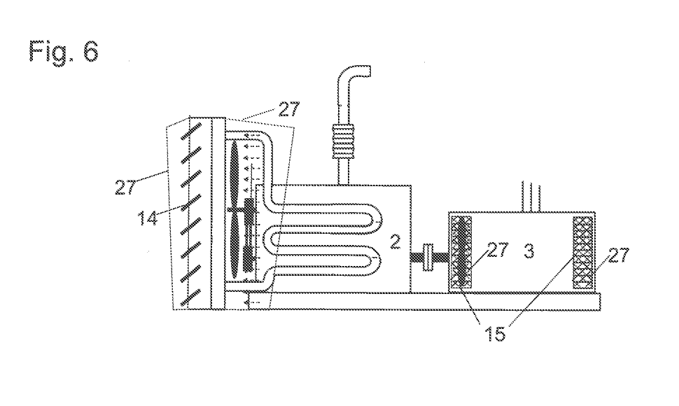

In FIG. 6 safety devices 27 are illustrated, located at the flaps 14, 15. This is to avoid injury during the operation of the flaps.

1. Method of operating a generator set, comprising a combustion engine with a drive shaft coupleable with a generator to supply electrical power, and at least one internal appliance coupleable to the drive shaft creating resistance to the drive shaft, particularly a fan, wherein a rotary speed of the drive shaft and/or a voltage and/or a frequency from the generator is monitored, wherein the resistance of the at least one internal appliance to the drive shaft is at least temporarily reduced when the rotation speed of the drive shaft and/or the voltage and/or the frequency from the generator drops below a predefinable threshold.

2. Method of operating a generator set according to claim 1, wherein the resistance against the drive shaft is reduced by uncoupling the internal appliance, particularly fan, from the drive shaft, preferably by a clutch.

3. Method of operating a generator set according to claim 1, wherein the at least one internal appliance is in the form of a fan coupled to the drive shaft, wherein a cooling air stream producible by the fan, wherein the resistance to the drive shaft is reduced by blocking the cooling air stream.

4. Method of operating a generator set according to claim 1, wherein the reduction of resistance is abrogated, when the rotary speed of the drive shaft and/or the voltage and/or the frequency from the generator is exceeding a predefinable second threshold.

5. A control system comprising a controller for a generator set comprising a combustion engine with a drive shaft coupleable with a generator and at least one internal appliance coupleable to the drive shaft creating resistance to the drive shaft, particularly a fan, wherein a at least one actuator is provided to affect the resistance of the at least one internal appliance to the drive shaft, wherein a rotary speed sensor is provided for monitoring a rotary speed of the drive shaft, wherein a output sensor is provided for monitoring the voltage and/or the frequency from the generator, wherein the rotary speed and/or the voltage and/or the frequency is communicable to the controller wherein when the rotation speed of the drive shaft and/or the voltage and/or the frequency from the generator drops below a predefinable threshold, the controller sends a actuating signal to the at least one actuator wherein the actuator reduces the resistance of the at least one internal appliance to the drive shaft.

6. A control system, according to claim 5, wherein the speed sensor is connected to the combustion engine and/or the generator monitoring the speed of the drive shaft and/or the generators shaft.

7. A control system, according to claim 5, wherein a clutch is provided to couple at least one internal appliance to the drive shaft, wherein the clutch is lockable by the actuator.

8. A control system, according to claim 5, wherein the internal appliance is in form of a fan coupled to the drive shaft generating an air stream, wherein the air stream is interruptible by at least one air directing means, particularly an adjustable flap, wherein a controller sends a actuating signal to the at least one actuator of the air directing means, to adjust a position of the air directing means.

9. A control system, according to claim 8, wherein the radiator flaps at the radiator fan can be located behind the radiator and, or between the radiator and the radiator fan and/or before the radiator fan.

10. A control system, according to claim 8, wherein the flaps at the generator can be located at the air inlet and/or the air outlet of the generator fan.

11. A control system, according to claim 9, wherein opening and closing the flaps is controllable in steps according to the setting of the threshold.

12. A control system, according to claim 5, wherein the level of the threshold can be set multiple and variable.

13. A control system, according to claim 5, wherein a safety device is located at the flaps.
